(19) United States
(12) Patent Application Publication
(10) Pub. No.: US 2013/0145426 A1
(43) Pub. Date: Jun. 6, 2013

(54) Web-Hosted Self-Managed Virtual Systems With Complex Rule-Based Content Access

(71) Applicants: Michael Wright, Chanhassen, MN (US); Peter Beacom, Bloomington, MN (US)

(72) Inventors: Michael Wright, Chanhassen, MN (US); Peter Beacom, Bloomington, MN (US)

(21) Appl. No.: 13/757,557

(22) Filed: Feb. 1, 2013

Related U.S. Application Data
(63) Continuation-in-part of application No. 12/723,598, filed on Mar. 12, 2010, now abandoned.

(51) Int. Cl. H04L 29/06

(52) U.S. Cl. CPC H04L 63/10
USPC 726/3

(57) ABSTRACT

A computer-based service provides methods and apparatus for a user to manage a collection of information that the user wishes to share with, or distribute to, one or more designated recipients, typically at a future time, where the user controls the contents of the collection, and the times and rules under which the collection, or portions of the collection, may be accessed by, or delivered to, the one or more designated recipients; and where the resources for storing, retrieving, processing and communicating the collection of information is logically centralized and remote from the user.

### CROSS-REFERENCE TO RELATED APPLICATIONS

This application is a continuation-in-part of, and claims the benefit of, U.S. application Ser. No. 12/723,598, titled WEB-HOSTED SELF-MANAGED VIRTUAL SYSTEMS WITH COMPLEX RULE-BASED CONTENT ACCESS, filed Mar. 12, 2010, which is hereby incorporated by reference in its entirety.

### COPYRIGHT AUTHORIZATION LANGUAGE UNDER 37 CFR §1.71(e)

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to computer-based services that provide each of a plurality of remote users with logically centralized resources for storage, retrieval, processing, and communication of information, and self-managed control mechanisms for controlling access to, and distribution of, portions of, or all of, a collection of information held by the logically centralized resources.

### BACKGROUND

Advances in semiconductor manufacturing technology, as well as in digital systems architecture and computer network infrastructure, have resulted in, among other things, the very widespread adoption of computer-based communication and social interaction by all segments of the population. These same advances have brought digital cameras and scanners into widespread use for capturing and digitizing images and documents.

Concurrently with the adoption of these technologies, there has developed a desire on the part of many people to collect their life stories and important documents, and to share these stories and documents, in a timely and appropriate manner, with family members and/or friends.

What is needed are methods and apparatus for a user to manage a collection of information that the user wishes to share with, or distribute to, one or more designated recipients, typically at a future time, where the user controls the contents of the collection, and the times and rules under which the collection, or portions of the collection, may be accessed by, or delivered to, the one or more designated recipients.

### SUMMARY OF THE INVENTION

Briefly, methods and apparatus for a user to manage a collection of information that the user wishes to share with, or distribute to, one or more designated recipients, typically at a future time, where the user controls the contents of the collection, and the times and rules under which the collection, or portions of the collection, may be accessed by, or delivered to, the one or more designated recipients; and where the resources for storing, retrieving, processing and communicating the collection of information is logically centralized and remote from the user.

### BRIEF DESCRIPTION OF THE DRAWINGS

FIG. 1 is a block diagram showing the communications relationship between a user system, a designated recipient system, and a service provider system.

FIG. 2 is a block diagram showing the logical relationship between vault access control, lock-box access control, and a content item in accordance with the present invention.

FIG. 3 is a block diagram showing the logical relationship between vault access control, lock-box access control, and a plurality of content items in accordance with the present invention.

FIG. 4 is a block diagram showing the logical relationship between vault access control, and a plurality of lock-box access controls, each lock-box including a plurality of content items in accordance with the present invention.

FIG. 5 is a block diagram showing the logical relationship between vault access control, and a plurality of content items in accordance with the present invention.

FIG. 6 is a flow diagram of a process in accordance with the present invention.

FIG. 7 is a flow diagram of a process in accordance with the present invention.

FIG. 8 is a block diagram illustrating vault and lock-box inventory lists in accordance with the present invention.

FIG. 9 illustrates part of an exemplary graphical user interface, in accordance with the present invention, where various content items in a selected vault are identified.

FIG. 10 illustrates part of an exemplary graphical user interface, in accordance with the present invention, where a content item is being edited.

FIG. 11 is a block diagram showing the communications relationship between a user system, a designated recipient system, a plurality of database sources and a service provider system.

FIG. 12 is a flow chart illustrating an example method of operating a service provider system in accordance with the present invention.

FIG. 13 is a block diagram showing an example backend data archive completely decoupled from user interface.

FIG. 14 illustrates part of an exemplary graphical user interface, in accordance with the present invention, wherein a user is browsing a multidimensional timeline interface.

FIG. 15 illustrates part of an exemplary graphical user interface, in accordance with the present invention, wherein a user is browsing a multidimensional timeline interface.

FIG. 16 illustrates part of an exemplary graphical user interface, in accordance with the present invention, wherein a user is browsing a multidimensional timeline interface.

FIG. 17 illustrates part of an exemplary graphical user interface, in accordance with the present invention, wherein a user is browsing a multidimensional timeline interface.

FIG. 18 illustrates part of an exemplary graphical user interface, in accordance with the present invention, wherein a user is browsing a multidimensional timeline interface.

FIG. 19 illustrates part of an exemplary graphical user interface, in accordance with the present invention, wherein a user is browsing a multidimensional timeline interface.

### DETAILED DESCRIPTION

Generally, various embodiments of the present invention provide methods and apparatus for a user to manage a collection of information that the user wishes to share with, or distribute to, one or more designated recipients, typically at a future time, where the user controls the contents of the collection, and the times and rules under which the collection, or portions of the collection, may be accessed by, or delivered to, the one or more designated recipients; and where the resources for storing, retrieving, processing and communicating the collection of information are logically centralized and remote from the user.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

### Terminology

Browser refers to a program which allows a user to read HTML files and information embedded in hypertext links in these files. The browser gives some means of viewing the contents of local and remote files and of navigating from one file to another using embedded hypertext links. Browsers act as clients to remote web servers. Safari (Apple, Inc.) and Internet Explorer (Microsoft Corporation) are examples of browsers for the World Wide Web. Browsers are sometimes referred to as web browsers.

Click refers to the user action of pressing a button on a mouse or other pointing device. This typically generates an event, also specifying the screen position of the cursor, which is then processed by a window manager or application program.

HTML (also html) refers to a hypertext document format used on the World Wide Web.

Hyperlink refers to a reference (link) from some point in one hypertext document to (some point in) another document or another place in the same document. A browser usually displays a hyperlink in some distinguishing way, e.g., in a different color, font or style. When a user activates the link (e.g., by clicking on it with the mouse) the browser will display the target of the link.

Hypertext refers to a collection of documents containing cross-references or “links” which, with the aid of an interactive browser program, allow the reader to move easily from one document to another.

HTTP (also http) refers to the client-server TCP/IP protocol used on the World Wide Web for the exchange of HTML documents.

Mouse refers to a common kind of input device connected to a computer system, also known as a pointing device. A mouse is moved over a flat surface and includes some means of converting its position, or its motions, in two dimensions into X-Y coordinates which the computer can read. The mouse typically has one or more buttons whose state can also be read by the computer to which it is coupled. Trackballs and joysticks are input devices with similar functionality. Wireless pointing devices that communicate with a computer by, for example, Bluetooth signaling, are also available and provide functionality substantially similar to that of the wired mouse.

Operating system refers generally to the software which schedules tasks, allocates storage, handles the interface to peripheral hardware and presents a default interface to the user when no application program is running.

Plug-in refers to a file containing data used to alter, enhance, or extend the operation of a parent application program. Various browsers support plug-ins. A plug-in is specific to a particular operating system and displays or interprets a particular file format such as Shockwave, RealAudio, or Adobe PDF.

Proxy gateway refers to a computer and associated software which will pass on a request for a URL from a World Wide Web browser to an outside server and return the results. This provides a trusted agent that can access the Internet on behalf of clients that are sealed off from the Internet. The client's user is typically not aware of the proxy gateway.

Proxy server refers to a World Wide Web server which accepts URLs with a special prefix. When it receives a request for such a URL, it strips off the prefix and looks for the resulting URL in its local cache. If found, it returns the document immediately, otherwise it fetches it from the remote server, saves a copy in the cache and returns it to the requester. The cache will usually have an expiry algorithm which flushes documents according to their age, size, and access history.

URL (Uniform Resource Locator) refers to a method for specifying an object on the Internet, such as a file. URLs are used extensively on the World Wide Web. They are used in HTML documents to specify the target of a hyperlink.

Web page refers to a block of data available on the World Wide Web, and identified by a URL. Each web page is usually stored on a server as a file written in HTML, possibly referring to images which appear as part of the page when it is displayed by a browser. A web page can also refer to other web pages and Internet resources by including hypertext links.

Web server refers to a server process running at a web site which sends out web pages in response to HTTP requests from remote browsers.

Web site refers to any computer on the Internet running a World Wide Web server process. A particular web site is identified by the hostname part of a URL.

World Wide Web refers to an Internet client-server hypertext distributed information retrieval system. The client program is known as a browser and runs on the user's computer. Documents represented as hypertext objects in HTML format are presented to the user in a graphical format by the browser. Hypertext links refer to other documents by their URLs. These can refer to local or remote resources.

The expression “service provider” refers to an entity that maintains and operates the storage, retrieval, computational, and communication resources needed to support a logically centralized system used in various embodiments of the present invention.

The expression “service provider system” refers to the storage, retrieval, computational, and communication resources needed to provide a logically centralized system used in various embodiments of the present invention.

The term “vault” as used herein refers to a logical repository for user content items. The vault is maintained by a service provider system. It is noted that although a vault is a logically singular construct, it is not required to be physically centralized. In accordance with the present invention, a user may have one or more vaults.

The expression “vault access control” as used herein refers to user specified instructions that are interpreted and executed by the service provider system to determine whether a vault access request from an entity other than the user should be granted.

The term “lock-box” as used herein refers to a logical repository for user content items. The lock-box is maintained by a service provider system, and is logically disposed in a vault. It is noted that although a lock-box is a logically singular construct, it is not required to be physically centralized. In accordance with the present invention, a user may have one or more lock-boxes.

The expression “lock-box access control” as used herein refers to user specified instructions that are interpreted and executed by the service provider system to determine whether a lock-box access request from an entity other than the user should be granted.

The term “legacy” as used herein refers to a collection of information that relates to a user.

The term “user” as used herein refers to an entity in control of a user system. The user communicates with the service provider system through the user system. The user is the “owner” of the vaults, lock-boxes, and content items created or submitted by him/her.

The term “subscriber” as used herein refers to a user that pays for the services of the service provider.

The expression “sponsored user” refers to a user for whom the service is paid for by a third party.

Some portions of the detailed descriptions which follow are presented in terms of algorithms and symbolic representations of operations on data bits within a computer system. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical, optical or magnetic signals capable of being stored, transferred, combined, compared, transformed and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is to be appreciated that throughout this disclosure, discussions utilizing terms such as “processing” or “computing” or “calculating” or “determining” or “displaying” or the like refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Overview

In some embodiments of the present invention, a computer-mediated service provides a legacy from a user to one or more designated recipients. The legacy may include, but is not limited to, stories, pictures, audio recordings, videos, and items for sharing that have been self-generated and/or gathered from friends, colleagues, and family. In some instances, the service provider, or a content provider, sells and/or licenses content to a user.

The legacy is a collection of information that a user wishes to share with, or distribute to, one or more designated recipients, typically at a future time, where the user controls the contents of the collection, and the times and rules under which the collection, or portions of the collection, may be accessed by, or delivered to, the one or more designated recipients. The legacy may include autobiography and/or contributed biography, each accessible for editing exclusively by the user. Contributed biography refers to materials obtained, provided, or submitted for inclusion in the legacy by sources other than the user. The collection may include information in any format suitable for storage, retrieval, and processing. Typical embodiments of the present invention store, retrieve, process, and communicate information in digital form. The present invention is not limited to any particular digital file format, storage medium, error correction scheme, or communications protocol. The information in the collection may represent items such as, but not limited to, text, images, pictures, videos, audio, computer programs, encryption/decryption keys, medical records, and legal documents. Information in the legacy collection may also include representations of multidimensional objects (for example, three-dimensional objects) captured by a scanner, laser measurement, or other means to capture multidimensional images and render them on a two-dimensional or other display, such as holographic display. Such representations may allow for recreation of physical artifacts via a three-dimensional printer or other technology.

In various embodiments of the present invention, the service provider system generates copies of some or all of the information in the collection. In some embodiments, the service provider system reformats some or all of the content items in the information collection in order to maintain compatibility and accessibility in view of hardware and/or software changes to the service provider system.

In one illustrative embodiment of the present invention, a service provider makes available to the user the resources (i.e., the service provider system) needed to create and administer the user's legacy. The contents of the legacy may be organized, as noted above, into an arrangement that includes one or more vaults, each vault being accessible by its owner, i.e., the user, and further accessible by designated recipients in accordance with rules of access specified by the user. Each vault may contain a portion of, or all of, the collection of information. Each vault may contain one or more lock-boxes, and each lock-box may contain a portion of, or all of, the collection of information. Each lock-box is accessible by the owner, and each lock-box is further accessible by designated recipients in accordance with rules of access specified by the user. In typical embodiments, the user has a plurality of vaults, and some of the vaults have one or more lock-boxes. A vault may contain content items without also containing a lock-box. A vault may contain content items and lock-boxes. Vaults and lock-boxes each have an identifier, or name, that is specified by the user. In alternative embodiments, the service provider system may provide a default name for a vault or lock-box and the user can simply accept the default name rather than providing a new identifier. The rules of access may be the same or different for each designated recipient.

In simple cases, the rules of access defined by a user for a particular designated recipient may be for that designated recipient to provide one or more passwords to the service provider system in order to gain access to some or all of the content. In some embodiments, the rules of access provide for associating temporal and/or geographical elements into access requests from designated users. That is, a user may specify as part of a rule set for accessing some or all of the content, that a designated user system communicate with the service provider system from a certain location and/or at a certain time. There are many well-known methods and apparatus for providing a designated recipient's system with location-awareness (e.g., Global Positioning System modules) and these methods and apparatus are not described in greater detail herein.

In some embodiments of the present invention, the geographical and/or temporal data in the access request of a designated recipient is used by the service provider to grant access to some content. In other embodiments, the geographical and/or temporal data in the access request of a designated recipient is used by the service provider to decrypt content that was previously encrypted in response to instructions received from the user system.

The user's legacy may include stories and media about himself/herself, and this material may be user-supplied, or obtained from friends, siblings, children and other relatives, as well as from colleagues at work or at play. The user's legacy may contain legal documents relating to wills, trusts, estates, taxes, insurance, location of assets, accounts and pass codes, physical safe deposit boxes, health directives, burial instructions, and so on.

A user may establish one or more vaults for content to be shared. By way of example, and not limitation, such content may include favorite lock-box identifiers, descriptions of things to see, descriptions of things to do, words of wisdom, recipes, books, information about people, games for different times in life, etc.

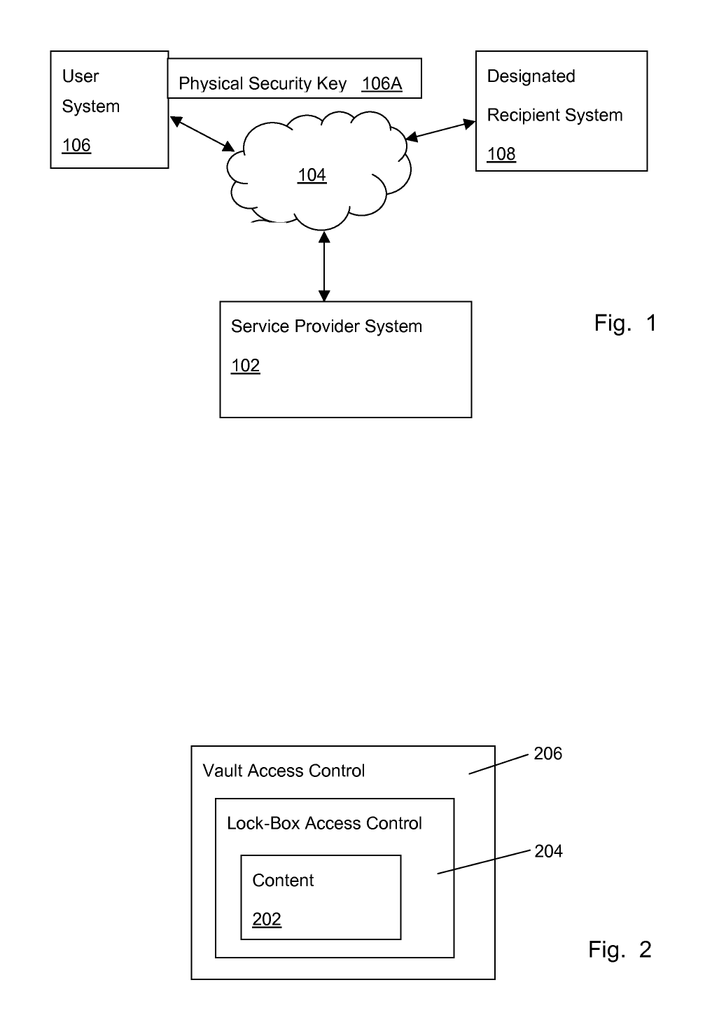

A designated recipient's access rights to one or more of the user's content items may be time-locked, such that those access rights are triggered by a calendar date and time, or by pre-defined events or conditions, that must occur. In some embodiments, a designated recipient's access rights are contingent upon possession of a physical key that is coupled to the designated user system (similar to physical key 106A shown in FIG. 1).

Referring to FIG. 1, a block diagram showing the communications relationship between a user system, a designated recipient system, and a service provider system is shown. More particularly, a service provider system 102 is coupled to communicate bidirectionally through a communications network, or cloud, 104, with a user system 106 and a designated recipient system 108. User system 106 may optionally include a physical security key 106A. Physical security key 106A may be supplied by the service provider to the user, and in embodiments requiring them, physical security key 106A must be coupled to user system 106 in order for the user to successfully access the service provider system 102. With respect to physical security key 106A, it is noted that such keys may include the circuitry and/or programming information such that they are only operational for a limited period of time. In some embodiments, physical security key 106A contains an “expiration date” in either hardware or software, and service provider system 102 does not allow user system 106 to access content or access control rules past the expiration date. In some embodiments the physical security key must be replaced subsequent to the expiration date and the user receives a replacement key from a service provider. In some embodiments, physical security key 106A is a permanent key, that is, it is issued once to a user, and if lost, application to the service provider for new key must be made by the user. It is further noted that physical security key 106A may include location-awareness circuitry so that it “knows” its location, and this location-based information may be communicated to a service provider to enable the next level of communication between a user or a designated recipient and the service provider, either as part of an initial handshaking sequence or as part of an access request verification process. In some embodiments, the presence of a physical object in close proximity to the user is required in order to allow access to secured data. Alternatively, the physical security key may contain geographical information defining one or more regions from which it will allow either communication with the service processor in general, or access to content in particular to proceed successfully. In other words, in some embodiments, physical possession of the physical key is not enough, but rather the physical key and the (user or designated) system must be in a predetermined region. In some embodiments, physical security key 106A communicates with user system 102 by means of a short range wireless communication protocol such as those that are commonly available today, or through a proprietary short-range wireless protocol. It will be appreciated that physical security keys such as 106A may also be required for use in designated recipient systems, and these uses are described in more detail below. The physical security key may be a hardware device used as an additional factor of authentication in addition to username and password credentials.

For security purposes, the service provider delivers, or arranges for the delivery of, the physical security key to a user. The same or similar procedures may be used for providing a physical security key to a designated recipient for use with a designated recipient system. In addition to expiration dates and/or the specification of authorized geographical regions from which access is permitted, the physical security keys may also contain biometric data which is compared to biometric information about a user (or a designated recipient as the case may be) that is gathered by the user system (or the designated recipient system). For example, a user system takes an image of the person using the system, and information regarding the image of the authorized user stored on the physical security key is used in determining whether the person operating the user system is indeed the authorized user. It will be appreciated that other biometric information, including but not limited to fingerprints, may be used in such a manner.

In some embodiments, a physical security key for a user system and/or a designated recipient system includes circuitry and/or programming that disables the physical security key after a pre-determined number of uses. This may be referred to as the key expiring.

Systems 102, 106, and 108 are each characterized by including computational and communication resources. In the illustrative embodiment of FIG. 1, user system 106 and designated recipient system 108 are devices such as, but not limited to, personal computers, netbooks, smartphones, and the like; and the communications cloud 104 is the Internet. In operation, service provider system 102 provides a first user interface, such as a graphical user interface, to user system 106, and provides a second user interface to designated recipient system 108. Typically, the first and second user interfaces are different. In alternative embodiments, the first and second user interfaces are the same, but provide different navigation paths for a user and a designated recipient. In alternative embodiments, it is possible for user system 106 and designated recipient system 108 to actually be simply user accounts on a larger system that communicates with service provider system 102. In a still further alternative, user system 102 and/or designated recipient system 108 are actually accounts on service provider system 102, and as such, service provider system 102 provides the bulk of the computational resources for the user and designated recipient interactions with service provider system 102.

Still referring to FIG. 1, service provider system 102 may include one or more web server processes running on one or more computers. Although service provider system 102 is shown as a single block in FIG. 1, those skilled in the art will appreciate that this system may be comprised of multiple computers which may be all physically co-located, or which may be physically distributed such that they are not co-located. In embodiments of the present invention where the computational resources that comprise service provider system 102 are not physically co-located, these resources are logically coupled via one or more communication networks such that an integrated system is formed. The present invention additionally contemplates that there may be elements of the service provider system which are not only not physically co-located but which are not logically coupled via one or more communication networks. In other words, the physically distributed logically centralized service provider system described above does not preclude remote backup storage facilities operated by the service provider.

FIG. 2 shows a block diagram of the logical relationship between vault access control 206, lock-box access control 204, and a content item 202 in accordance with the present invention. Logically, content item 202 is in a lock-box, entry into which is determined by lock-box access control 204; the lock-box itself is in a vault, entry into which is determined by vault access control 206. Referring to both FIGS. 1 and 2, content item 202 is typically provided to service provider system 102 by user system 106, from which service provider system 102 further receives one or more vault identifiers and vault access rules, and one or more lock-box identifiers and lock-box access rules. In the illustrative embodiment of FIG. 2, content item 202 is associated with lock-box access control 204 and vault access control 206. The access rules define the actions required to be performed, and/or data to be submitted, by at least one designated recipient system in order to access content item 202.

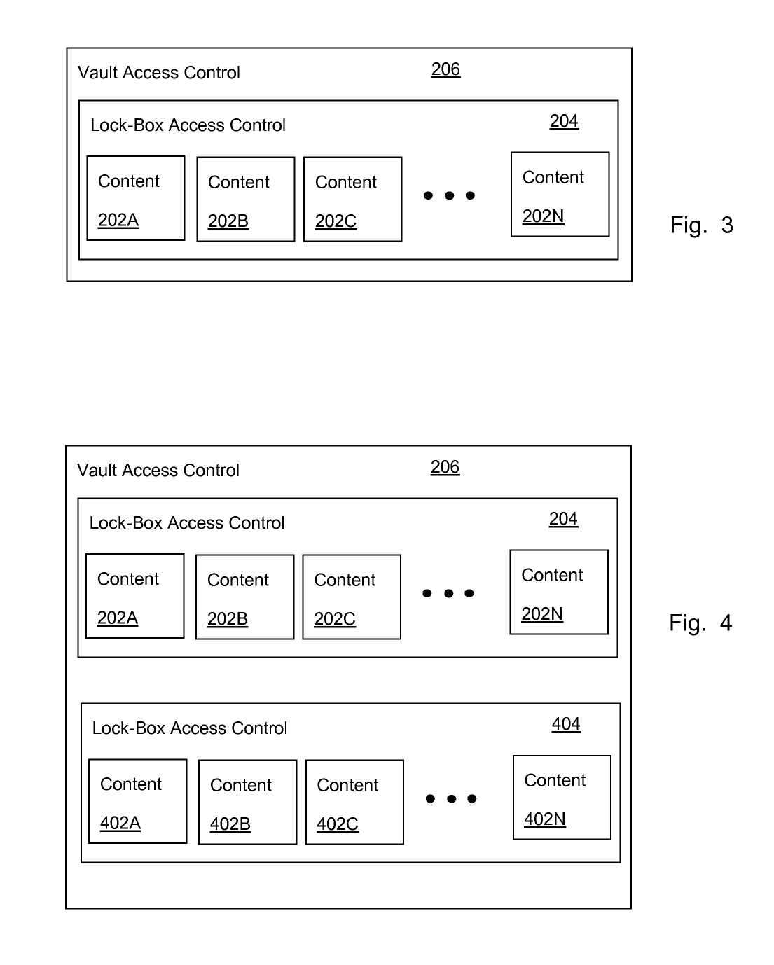

FIG. 3 is a block diagram showing the logical relationship between vault access control, lock-box access control, and a plurality of content items in accordance with the present invention. FIG. 3 is similar to FIG. 2, but illustrates that a plurality of content items 202A, 202B, 202C . . . 202N, may be associated with a particular lock-box and lock-box access control 204.

FIG. 4 is a block diagram showing the logical relationship between vault access control, and a plurality of lock-box access controls, each lock-box including a plurality of content items in accordance with the present invention. FIG. 4 is similar to FIG. 3, but illustrates that a plurality of lock-boxes, each with its own lock-box access control 204, 404, may be associated with a particular vault and vault access control 206. In the illustrative embodiment of FIG. 4, a plurality of content items 402A, 402B, 402C . . . 402N, are associated with lock-box access control 404.

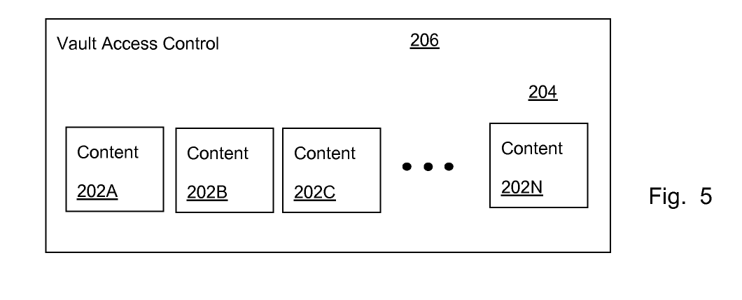

FIG. 5 is a block diagram showing the logical relationship between vault access control, and a plurality of content items in accordance with the present invention. FIG. 5 is similar to FIG. 2, but content items 202A, 202B, 202C . . . 202N, are logically placed directly in a vault rather than in a lock-box. Permission to access one or more of content items 202A, 202B, 202C . . . 202N, is determined, at least in part, by the vault access rules of vault access control 206.

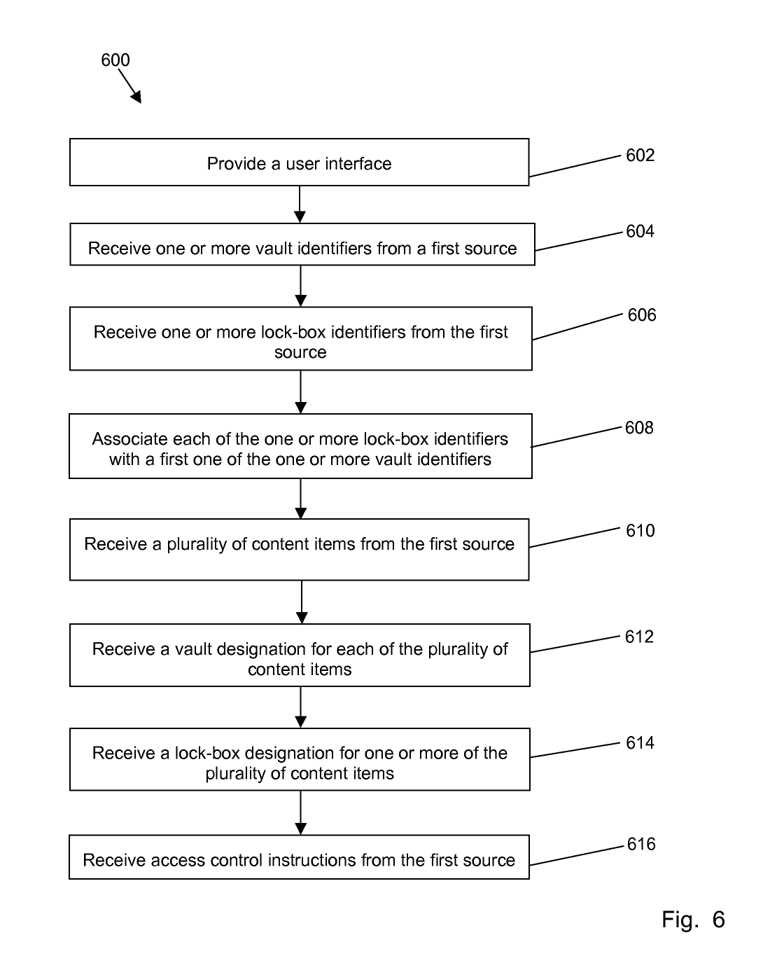

FIG. 6 is a flow diagram illustrating a method 600, in accordance with the present invention, that includes providing 602, from the service provider system, a user interface; receiving 604, at the service provider system, one or more vault identifiers from a first source; receiving 606, at the service provider system, one or more lock-box identifiers from the first source; associating 608, at the service provider system, each of the one or more lock-box identifiers with a first one of the one or more vault identifiers; receiving 610, at the service provider system, a plurality of content items from the first source; receiving 612, at the service provider system, a vault designation for each of the plurality of content items; receiving 614, at the service provider system, a lock-box designation for one or more of the plurality of content items; and receiving 616, at the service provider system, access control instructions from the first source; wherein the access control instructions determine the operations required by a designated recipient to access one or more content items.

In one embodiment, method 600 further includes receiving, at the service provider system, content modification instructions from the first source. Content modification instructions may include, but are not limited to, delete a content item, replace a content item, make specified edits to a content item, make the same change to a list of content items, and convert the format of a content item to a different format. This embodiment may further include modifying at least one content item in accordance with the content modification instructions from the first source, i.e., the computational resources of the service provider carry out the content modification instructions.

In another embodiment, method 600 further includes generating, at the service provider system, an inventory list for at least one vault, and/or generating an inventory list for at least one lock-box. An inventory list, in accordance with the present invention, provides information identifying the lock-boxes and/or content items in a vault; or the content items in a lock-box. The inventory lists are generated by the service provider system, and communicated to a requesting system. The requesting system may be a user system, or may be a designated recipient system if that designated recipient system meets the inventory list access control rules. It is noted that access control rules may be different for accessing inventory lists than for accessing content.

In another embodiment, method 600 includes receiving, at the service provider system, content distribution instructions from the first source. In this case, the first source is the user system, and the content distribution instructions specify one or more notifications, one or more content items, and/or one or more inventory lists, that are to be transmitted to one or more designated recipient systems by the service provider system. In some embodiments, the notifications are pushed, by the service provider system, to the designated recipient system, whereas the inventory lists and content items are provided only when the designated recipient system communicates with, and is authenticated by, the service provider system. In some embodiments, the content distribution instructions may specify delivery of content to a designated recipient by any suitable means, including, for example, the production of physical copies of the content items, and delivery thereof.

Still referring to FIG. 6, various embodiments of method 600 may further include receiving, at the service provider system, an access request from a designated recipient system, and the service provider system determining whether to grant the access request from the designated recipient system based, at least in part, on the vault and/or lock box access control rules for the content to which access was requested. It is noted that the access request for a content item includes a vault identifier, and may further include a lock-box identifier.

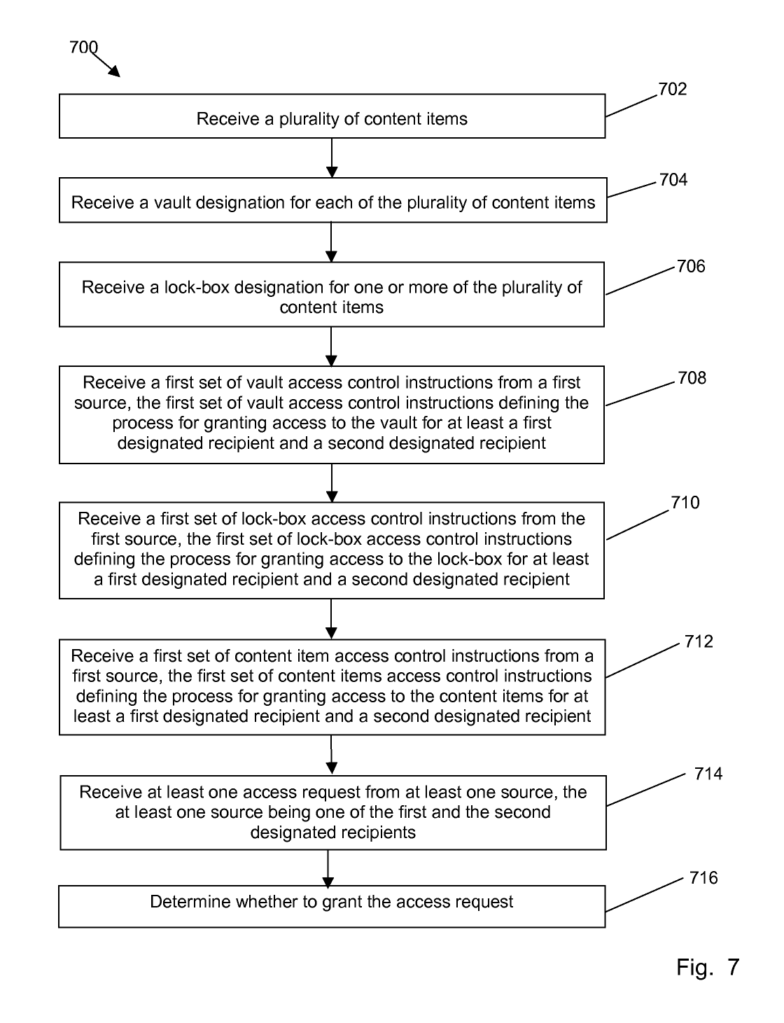

FIG. 7 is a flow diagram of a method 700 in accordance with the present invention, that includes receiving 702 at the service provider system, a plurality of content items; receiving 704 at the service provider system, a vault designation for each of the plurality of content items; receiving 706 at the service provider system, a lock-box designation for one or more of the plurality of content items; receiving 708 at the service provider system, a first set of vault access control instructions from a first source, the first set of vault access control instructions defining the process for granting access to the vault for at least a first designated recipient and a second designated recipient; receiving 710 at the service provider system, a first set of lock-box access control instructions from the first source, the first set of lock-box access control instructions defining the process for granting access to the lock-box for at least a first designated recipient and a second designated recipient; receiving 712 at the service provider system, a first set of content item access control instructions from a first source, the first set of content items access control instructions defining the process for granting access to the content items for at least a first designated recipient and a second designated recipient; receiving 714 at the service provider system, at least one access request from at least one source, the at least one source being one of the first and the second designated recipients; and determining 716 at the service provider system, whether to grant the access request. Typically, the plurality of content items originate from the first source, and the first source is a user system.

In one embodiment, method 700 further includes receiving, at the service provider system, one or more first designated recipient access requests, the access requests originating from a first designated recipient system.

In some embodiments, method 700 may further include receiving, at the service provider system, one or more second designated recipient access requests, the access requests originating from a second designated recipient system. It is noted that in some embodiments of method 700 the first set of vault access control instructions specifies concurrent on-line presence of both the first and the second designated recipient systems in order to access the vault.

It is noted that in some embodiments, the service provider system may communicate with a designated recipient from which an access request has been received and request credit card or debit card information. The service provider system may then communicate with the computer system of the appropriate financial institution to place a block on the credit card or debit account, pending the outcome of the determination of whether to grant an access request. In this way, hackers may be discouraged from attempting to gain unauthorized access to a user's legacy.

Various embodiments of method 700 may further include receiving, at the service provider system, vault and/or lock-box creation information from a user system.

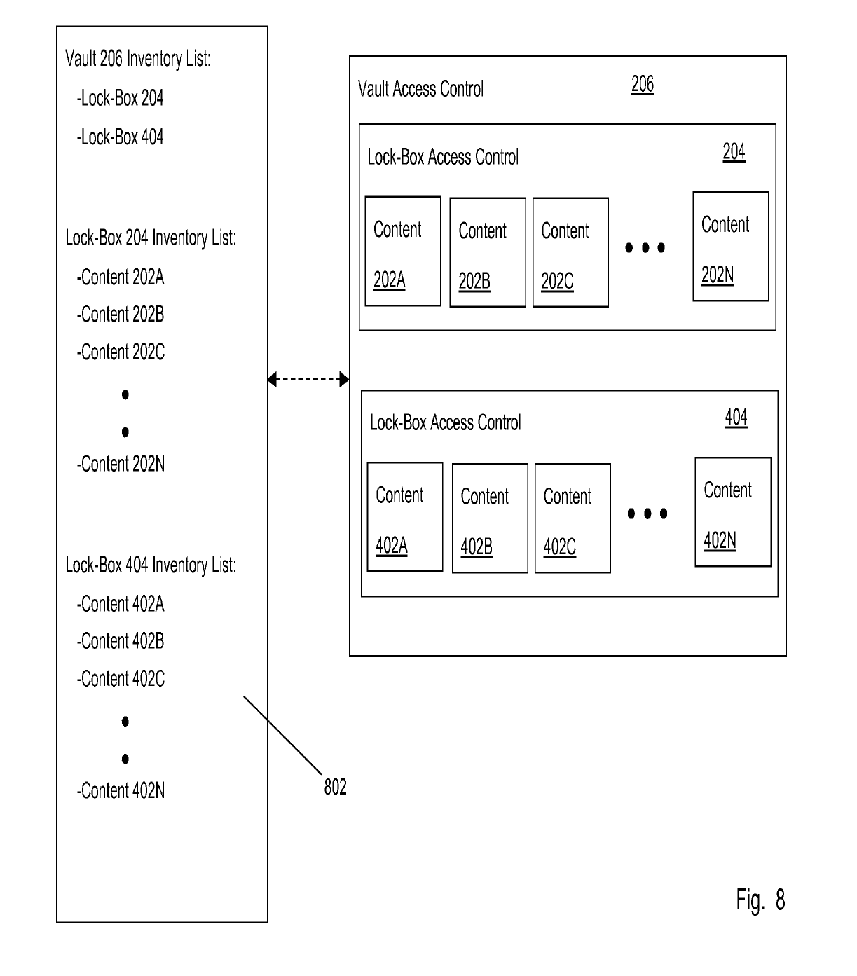

Referring to FIG. 8, a block diagram illustrating inventory lists for vaults and lock-boxes is shown. In this exemplary embodiment, block 802 contains the information, extracted, at least in part, by the service provider system, regarding the content of a vault and two lock-boxes. When an inventory list is requested by a designated recipient, the content of the inventory list may be redacted, that is filtered, by the service provider system based, at least in part, on the access control instructions provided by the user. That is, where multiple designated recipients are specified by the user, each of the designated recipients may only be permitted to receive an inventory list of the items that they have been authorized to view in accordance with the access control instructions provided by the user.

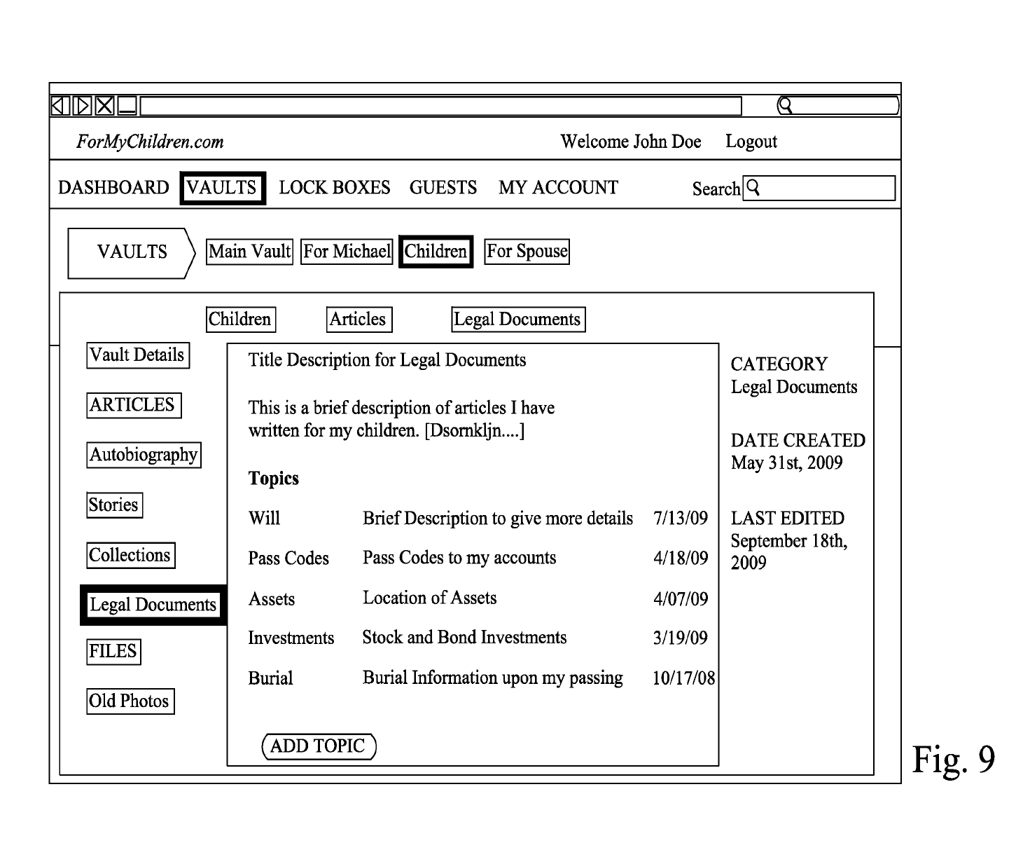

Referring to FIG. 9, part of an exemplary graphical user interface, as it may appear on a computer screen or equivalent display of the user system, is shown. The illustrative embodiment of FIG. 9 shows various content items from a selected vault. Additionally, the illustrative embodiment of FIG. 9 shows various menu items for control, navigation, and content access.

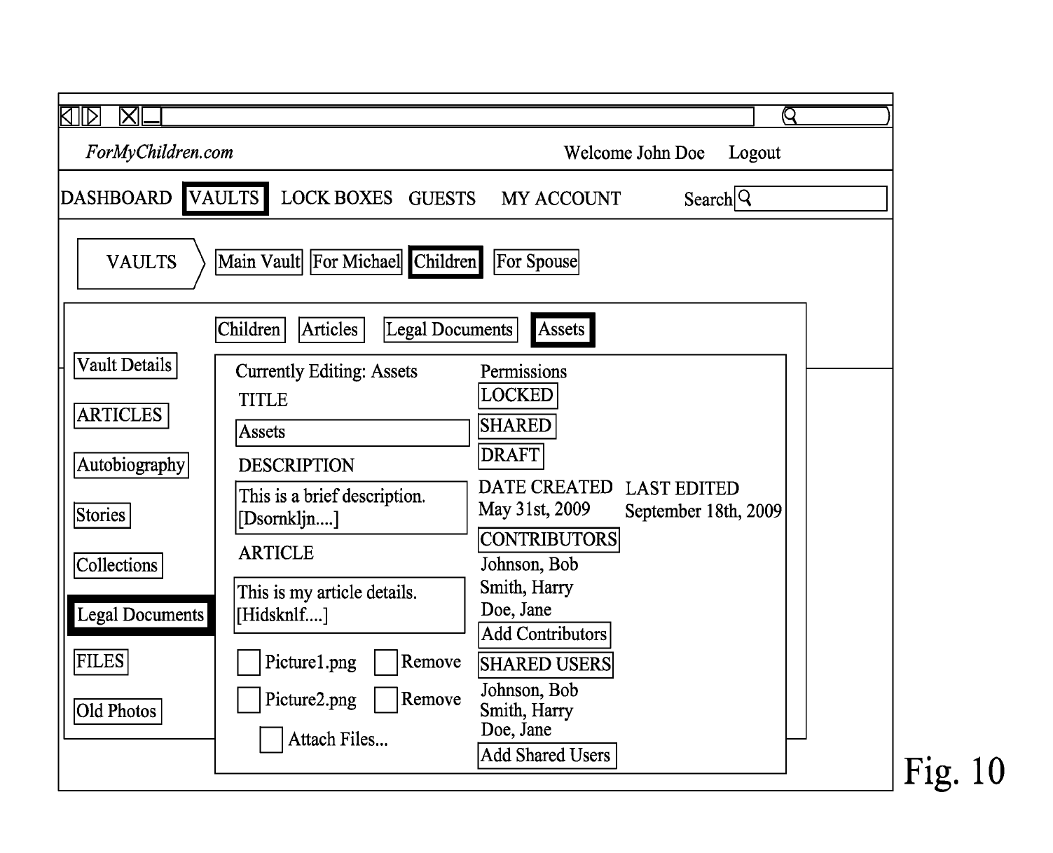

Referring to FIG. 10, part of an exemplary graphical user interface, as it may appear on a computer screen or equivalent display of the user system, is shown, where a selected content item is being edited. Those skilled in the art and having the benefit of this disclosure will recognize that the graphical user interface is typically provided to a user by the service provider, and will further recognize that the execution of software code to produce the display may be distributed between the service provider and the user system. In some embodiments, the content item remains with the service provider and the service provider receives instructions (e.g., data, commands, code, or the like) from the user system which are applied by the service provider to the content item to achieve the desired edits. In other embodiments, the content item is communicated to the user system from the service provider, the content item is edited locally on the user system, and the edited content is then returned to the service provider from the user system.

Referring to FIG. 13, in some embodiments, the back-end data archive is completely decoupled from the front-end user interface. The system can be adapted for future interfaces and to address different cultural uses of data.

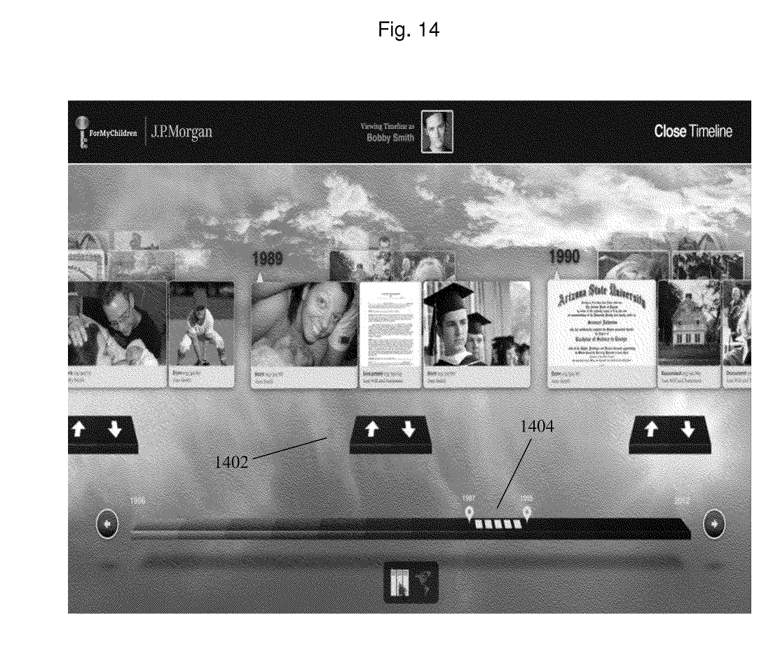

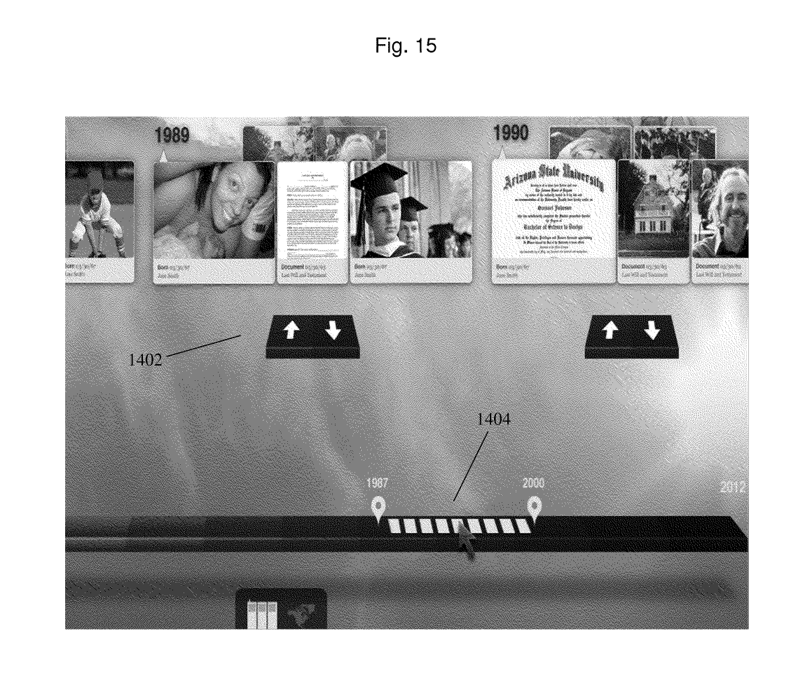

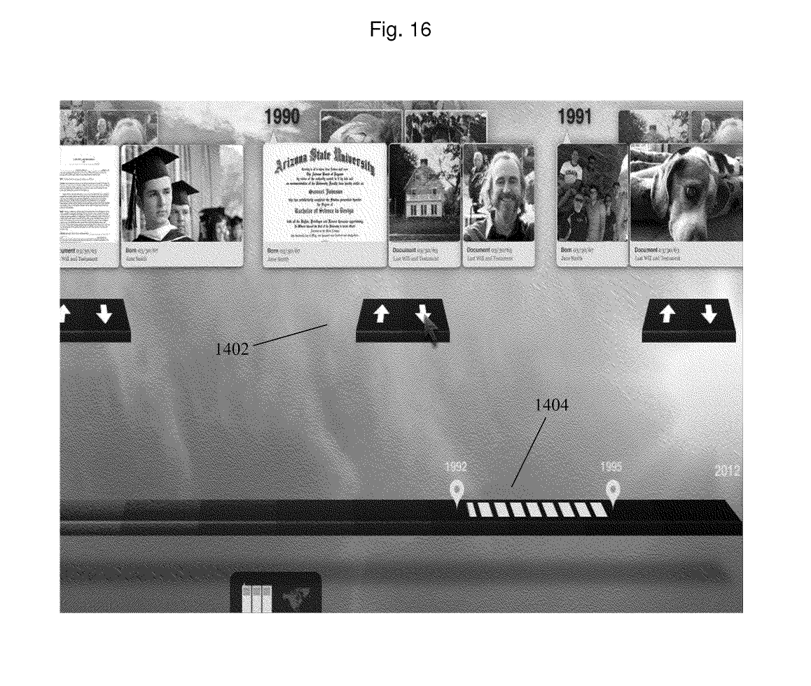

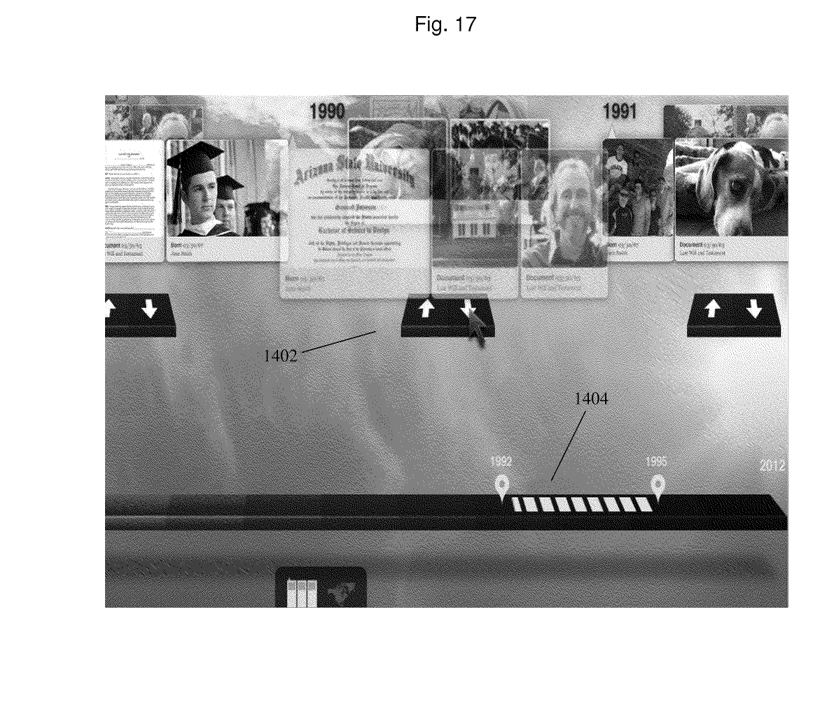

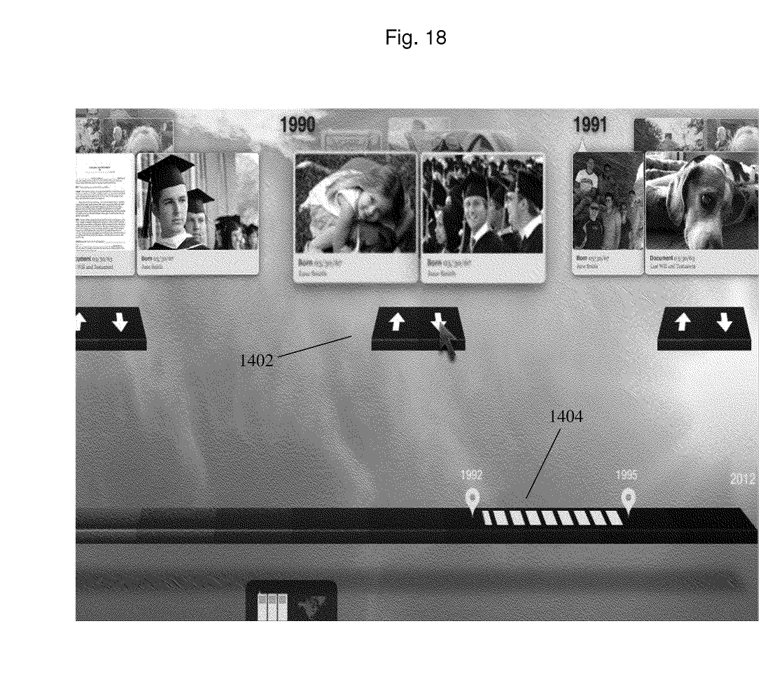

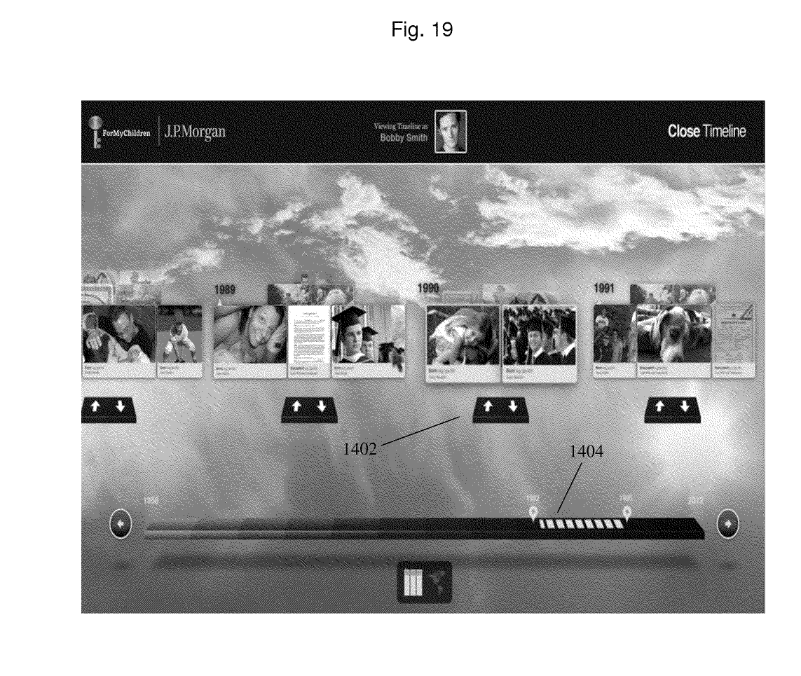

Referring to FIG. 14 through FIG. 19, a multidimensional timeline user interface allows for the browsing of different sized epoch along different axes in some embodiments of the present invention. The user interface provides a means for users to browse life events along multiple axes. For example, the x-axis 1404 may be divided into years and the user may scroll left and right along it as a traditional timeline. The z-axis 1402 may be divided into months. So while at a particular year on the x-axis 1404, the user can also scroll in and out to browse individual months on the z-axis 1402. Likewise, at a particular month, the y-axis could be divided into days, or more likely individual life events, and the user can scroll up and down to view the life events. The assignment of epochs to axes is arbitrary and could be user configurable. An alternative user interface could have decades on the y-axis, years on the x-axis, and individual life events on the z-axis. Axes may be reused as well. A user could have decades on the x-axis, years on the z-axis, and then use an additional x-axis to display months. The actual scrolling may be accomplished through a normal user interface means such as keyboard, mouse click, mouse wheel, or gesture.

In one illustrative embodiment of the present invention, a method is provided for a parent to create and maintain a virtual legacy vault for the purpose of preserving the individual information of the parent for the specific use of his/her child(ren). The virtual legacy vault in accordance with the present invention allows a single user, through the interaction of a user system and a service provider system, to establish multiple vaults which may only be accessed by a security protocol, such as, but not limited to, double password protection. In this illustrative embodiment, a first password is generated by the user and a second password is generated by the computational resources of the service provider, i.e., the service provider system. A record of each access may be stored by the service provider system. Each vault specific to an area of functionality contains one or more subset lock-boxes, and each such lock-box is also double password protected with the user generating both passwords. Each lock-box of this illustrative embodiment can be partitioned by time, content, and/or security access level, where the security access level may be, for example, one of owner, executor, child(ren), and guest.

### End of Life Notification

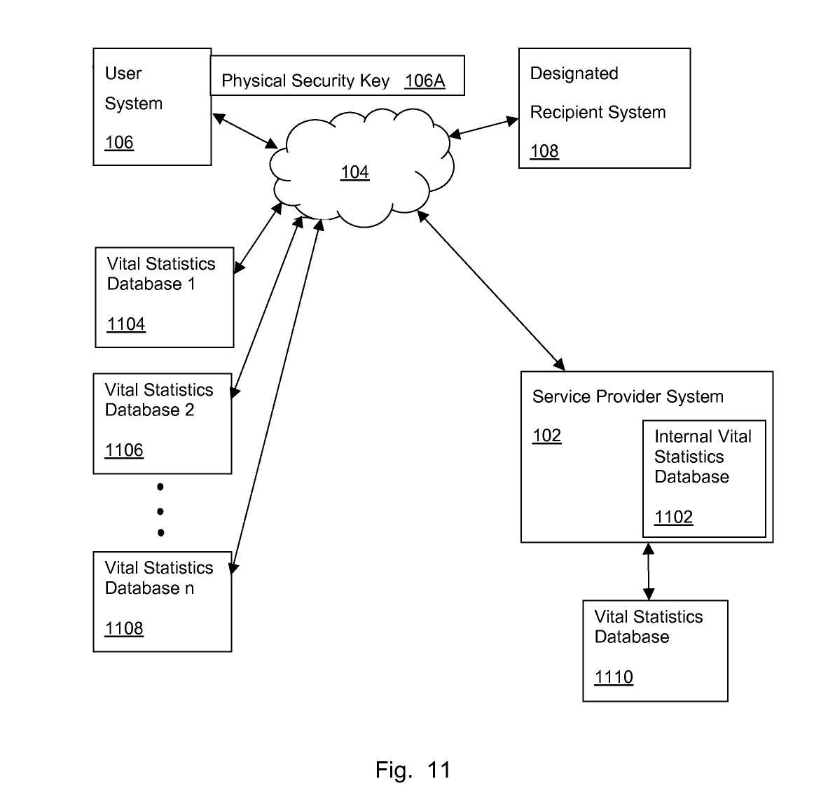

In some embodiments of the present invention, the service provider system is coupled to one or more vital statistics databases. Such vital statistics databases may be of governmental origin or private origin. Such an arrangement is illustrated in FIG. 11, which is similar to FIG. 1, but further shows an internal vital statistics database 1102, vital statistics databases 1104, 1106 and 1108 coupled to service provider 102 through a communications cloud, and a vital statistics database 1110 coupled to service provider 102 through a direct communications path. It is noted that service provider 102 can maintain its own internal database of vital statistics 1102, by receiving data and updating its records, but typically it is more efficient for service provider 102 to couple to one or more external such databases 1104, 1106, 1108, 1110, since the effort to update and maintain the external databases, and the availability of source information for updating the external databases is taken care of external to service provider 102. The present invention is not limited to any particular method or means of communicating information between databases 1104, 1106, 1108, 1110, and service provider 102. It is noted that service provider 102 may be coupled directly, indirectly, or not at all to external databases. It is further noted that service provider 102 may be coupled to external databases that provide information other than vital statistics.

Service provider system 102, based at least in part on the instructions received from a user system 106, and the information obtained from one or more vital statistics databases 1104, 1106, 1108, 1110, may determine that a user has died, and responsive to that determination, service provider system 102 transmits various notifications and/or content items as directed by the user's previously established instructions. In some embodiments, responsive to the determination that a user has died, service provider system 102 may modify the access control rules for vaults and/or lock-boxes in accordance with user-specified instructions, and/or in accordance with predetermined procedures of service provider system 102 itself.

### Lack of Capacity Notification

In another embodiment, similar to the End of Life Notification embodiment described above, the service provider system, based at least in part on the instructions received from a user system, and the information obtained from one or more pre-authorized sources, may determine that a user has become incapacitated and/or incompetent, and responsive to that determination, the service provider system transmits various notifications and/or content items as directed by the user's previously established instructions. In some embodiments, responsive to the determination that a user has become incapacitated and/or incompetent, the service provider system may modify the access control rules for vaults and/or lock-boxes in accordance with user-specified instructions, and/or in accordance with predetermined procedures of service provider system itself.

### Revenue Generation

In some embodiments the service provider receives revenue from advertisers whose advertising content is delivered by the service provider system to user systems and/or designated recipient systems. In some instances the advertising content is required to be interacted with by the user and/or designated recipient in order for a certain amount of revenue to be realized by the service provider. In accordance with the present invention, notice of such interactions with advertising content are received by the service provider system from the user and/or designated recipient systems, the service provider system then aggregates and characterizes the interaction data and communicates the appropriate information to the advertiser(s) and the service provider receives payment accordingly.

In some embodiments, a fee is charged for preparing one or more physical security keys for one or more users and/or designated recipients. Alternatively, the physical security key may be prepared without charge, and a shipping and handling fee is charged for delivery of the one or more physical security keys.

In some embodiments, a fee may be charged for preparation and/or delivery of a replacement physical security key.

In some embodiments, the fee charged in connection with a physical security key is based, at least in part, on the number of uses that are permitted for the physical security key before that key expires.

In some embodiments, the service provider system provides one or more “plug-in” software modules to a user and/or designated recipient system in exchange for a fee. Such fees may be charged prior to allowing a user and/or designated recipient to download the plug-in software module, or may simply be added to a period bill that is generated by the service provider system and communicated (electronically or otherwise) to the respective user and/or designated recipient.

In some embodiments, a fee may be charged when the service provider system provides, to a user system, information regarding the history of access requests and/or information regarding the identity of systems making access requests, and/or which of the access requests were granted, and/or which content items were accessed. It is noted that payment of such a fee may occur by automatic electronic funds transfer, checking account debit, or credit card charge initiated by action of the service provider system.

In some embodiments, a fee may be charged, or a discount may be offered to a subscriber or a sponsor, for directing the service provider system, responsive to determining that a user has died, to perform, or refrain from performing, a particular modification to one or more vault and/or access control rules of the user that has died.

In some embodiments, a fee may be charged to a subscriber or sponsor by the service provider system, for the service provider system providing one or more content items to a user.

### One Illustrative Embodiment

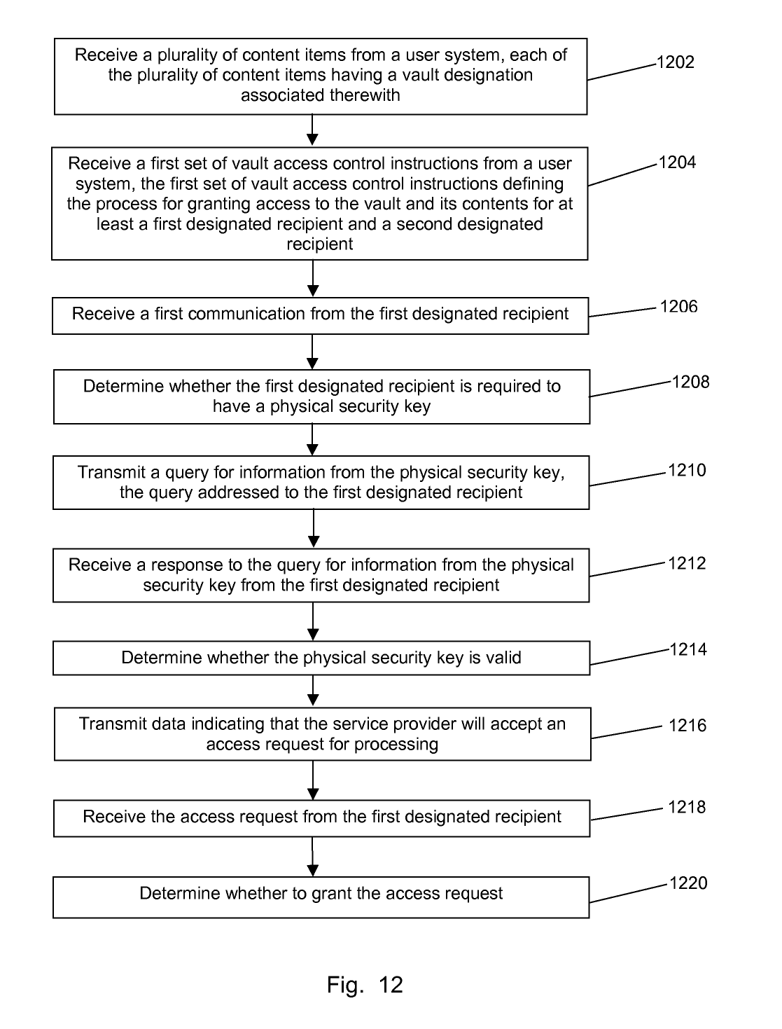

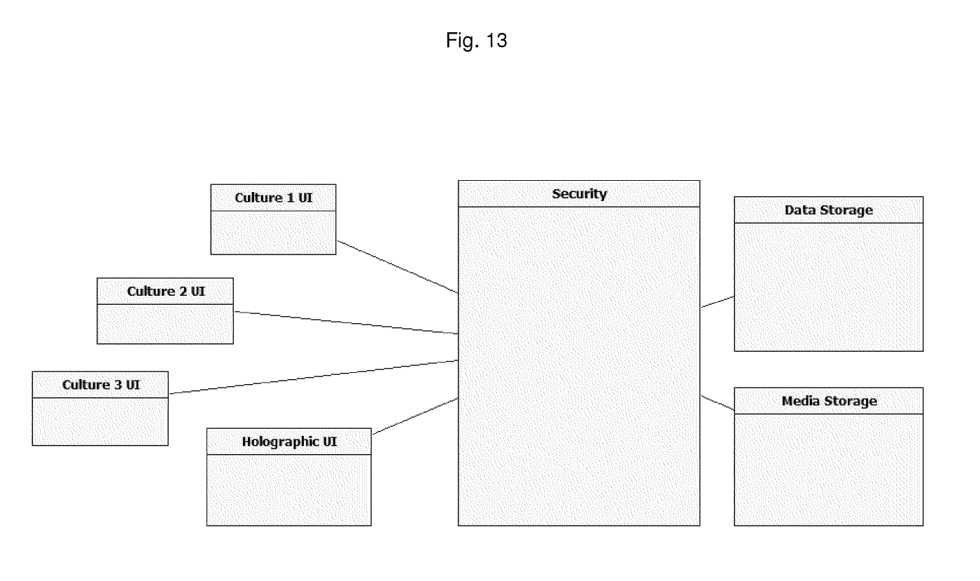

In accordance with the present invention, as illustrated in FIG. 12, a method of operating a service provider system, includes (a) receiving 1202, at the service provider system, a plurality of content items from a user system, each of the plurality of content items having a vault designation associated therewith; (b) receiving 1204, at the service provider system, a first set of vault access control instructions from a user system, the first set of vault access control instructions defining the process for granting access to the vault and its contents for at least a first designated recipient and a second designated recipient; (c) receiving 1206, at the service provider system, a first communication from the first designated recipient; (d) determining 1208, at the service provider system, whether the first designated recipient is required to have a physical security key; (e) transmitting 1210, from the service provider system if the determination of (d) is affirmative, a query for information from the physical security key, the query addressed to the first designated recipient; (f) receiving 1212, at the service provider system, a response to the query for information from the physical security key from the first designated recipient; (g) determining 1214, at the service provider system, whether the physical security key is valid; (h) transmitting 1216, from the service provider system if the determination of (g) is affirmative, data indicating that the service provider will accept an access request for processing; (i) receiving 1218, at the service provider system, the access request from the first designated recipient; and (j) determining 1220, at the service provider system, whether to grant the access request. In some embodiments, the response to the query for information from the physical key includes one or more data items from the group consisting of geographical data, expiration date data, and biometric data. In some embodiments, determining whether the first designated recipient is required to have a physical security key includes accessing, by the service provider system, at least a portion of the contents of the first set of vault access control instructions from the user system, the portion specifying whether a physical security key is required by the first designated recipient. In some embodiments, determining whether the physical security key is valid comprises accessing, by the service provider system, at least one record from a physical key database maintained by the service provider system. Typically, the physical key database includes information that specifies what information is required either directly from the physical key or from the designated system based on the information in the key. The service provider maintains the physical key database since it is the entity that generates and provides the physical security keys.

### CONCLUSION

The exemplary methods and apparatus illustrated and described herein find application in at least the fields of information preservation and communication, historical record keeping, and genealogical research.

One advantage of the present invention is that people can collect, edit, and format information about their lives, families, and businesses; and control when and to whom various portions of the collected information will be made accessible.

Another advantageous feature of the present invention includes the user specification of access rules that require two or more designated recipients to be concurrently authenticated by the service provider system in order to satisfy an access control rule and gain access to a content item.

The present invention can be embodied in the form of methods and apparatuses for practicing those methods. The present invention can also be embodied in the form of computer program code embodied in tangible media, such as floppy diskettes, CD-ROMs, DVDs, Flash memories, hard drives, or any other computer-readable storage medium, wherein, when the computer program code is loaded into and executed by a computer, the computer becomes an apparatus for practicing the invention. The program code encoded in tangible media creates the means for causing the computer to perform the various steps of the present invention. The present invention can also be embodied in the form of computer program code, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code combines with the microprocessor to provide a unique device that operates analogously to specific logic circuits.

It will be understood that various other changes in the details, materials, and arrangements of the parts and steps which have been described and illustrated in order to explain the nature of this invention may be made by those skilled in the art without departing from the principles and scope of the invention as expressed in the subjoined claims.

What is claimed is:

1. A method, comprising:
providing, from a service provider system, a user interface;
receiving, at the service provider system, one or more vault identifiers from a first source;
receiving, at the service provider system, one or more lock-box identifiers from the first source;
associating, at the service provider system, each of the one or more lockbox identifiers with a first one of the one or more vault identifiers;
receiving, at the service provider system, a plurality of content items from the first source;
receiving, at the service provider system, a vault designation for each of the plurality of content items;
receiving, at the service provider system, a lock-box designation for one or more of the plurality of content items; and
receiving, at the service provider system, access control instructions from the first source;
wherein the access control instructions determine the information required to be received by the service provider system prior to granting access one or more content items by a designated recipient.

2. The method of claim 1, further comprising receiving, at the service provider system, content modification instructions from the first source.

3. The method of claim 2, further comprising modifying, at the service provider system, at least one content item in accordance with the content modification instructions from the first source.

4. The method of claim 1, further comprising generating, at the service provider system, an inventory list for at least one vault.

5. The method of claim 1, further comprising generating, at the service provider system, an inventory list for at least one lock-box.

6. The method of claim 1, further comprising receiving, at the service provider system, content distribution instructions from the first source.

7. The method of claim 1, further comprising:
receiving, at the service provider system, an access request from a second source, and
determining, at the service provider system, whether to grant the access request from the second source.

8. The method of claim 7, wherein the access request from the second source includes a vault identifier.

9. The method of claim 7, wherein the access request from the second source includes a lock-box identifier.

10. The method of claim 1, further comprising receiving, at the service provider system, an inventory list request from a designated recipient system.

11. A method of operating a service provider service, using a computing system comprising at least one server and at least one computing device communicably coupled to the at least one server through a communication network, the method comprising:
providing a non-transitory computer readable medium encoded with instructions and executed by a processor to perform the steps of:
causing at least one processor to execute a plurality of instructions stored in at least one memory device to operate with at least one input device to receive input regarding a plurality of content items;
causing at least one processor to execute a plurality of instructions stored in at least one memory device to operate with at least one input device to receive input regarding a vault designation for each of the plurality of content items;
causing at least one processor to execute a plurality of instructions stored in at least one memory device to operate with at least one input device to receive input regarding, a lock-box designation for one or more of the plurality of content items;
causing at least one processor to execute a plurality of instructions stored in at least one memory device to operate with at least one input device to receive input regarding a first set of vault access control instructions from a first source, the first set of vault access control instructions defining the process for granting access to the vault for at least a first designated recipient and a second designated recipient;
causing at least one processor to execute a plurality of instructions stored in at least one memory device to operate with at least one input device to receive input regarding a first set of lock-box access control instructions from the first source, the first set of lock-box access control instructions defining the process for granting access to the lock-box for at least a first designated recipient and a second designated recipient;
causing at least one processor to execute a plurality of instructions stored in at least one memory device to operate with at least one input device to receive input regarding a first set of content item access control instructions from a first source, the first set of content items access control instructions defining the process for granting access to the content items for at least a first designated recipient and a second designated recipient;
causing at least one processor to execute a plurality of instructions stored in at least one memory device to operate with at least one input device to receive input regarding at least one access request from at least one source, the at least one source being one of the first and the second designated recipients; and
causing the at least one processor to execute the plurality of instructions stored in the at least one memory device to determine whether to grant the at least one access request.

12. The method of claim 11, wherein the plurality of content items originate from the first source, and the first source is a user system.

13. The method of claim 11, further comprising receiving, at the service provider system, one or more first designated recipient access requests, the access requests originating from a first designated recipient system.

14. The method of claim 13, further comprising receiving, at the service provider system, one or more second designated recipient access requests, the access requests originating from a second designated recipient system.

15. The method of claim 14, wherein the first set of vault access control instructions specifies concurrent on-line presence of both the first and the second designated recipient systems in order to access the vault.

16. The method of claim 13, further comprising receiving at the service provider system, a first set of information from physical security key that is communicatively coupled to the first designated recipient system.

17. The method of claim 16, wherein the first set of information includes one or more of group consisting of geographical data, expiration date data, and biometric data.

18. The method of claim 11, further comprising receiving, at the service provider system, vault creation information from a user system.

19. The method of claim 11, further comprising receiving, at the service provider system, lock-box creation information from a user system.

20. A method of operating a service provider service, using a computing system comprising at least one server and at least one computing device communicably coupled to the at least one server through a communication network, the method comprising:
providing a non-transitory computer readable medium encoded with instructions and executed by a processor to perform the steps of:
(a) causing at least one processor to execute a plurality of instructions stored in at least one memory device to operate with at least one input device to receive input regarding a plurality of content items from a user system, each of the plurality of content items having a vault designation associated therewith;
(b) causing at least one processor to execute a plurality of instructions stored in at least one memory device to operate with at least one input device to receive input regarding a first set of vault access control instructions from a user system, the first set of vault access control instructions defining the process for granting access to the vault and its contents for at least a first designated recipient and a second designated recipient;
(c) causing at least one processor to execute a plurality of instructions stored in at least one memory device to operate with at least one input device to receive input regarding a first communication from the first designated recipient;
(d causing the at least one processor to execute the plurality of instructions stored in the at least one memory device to determine whether the first designated recipient is required to have a physical security key;
(e) transmitting, from the service provider system if the determination of (d) is affirmative, a query for information from the physical security key, the query addressed to the first designated recipient;
(f) causing at least one processor to execute a plurality of instructions stored in at least one memory device to operate with at least one input device to receive input regarding a response to the query for information from the physical security key from the first designated recipient;
(g) causing the at least one processor to execute the plurality of instructions stored in the at least one memory device to determine whether the physical security key is valid;
(h) causing the at least one processor to execute the plurality of instructions stored in the at least one memory device to transmit input if the determination of (g) is affirmative, data indicating that the service provider will accept an access request for processing
(i) causing at least one processor to execute a plurality of instructions stored in at least one memory device to operate with at least one input device to receive input regarding the access request from the first designated recipient; and
(j) causing the at least one processor to execute the plurality of instructions stored in the at least one memory device to determine whether to grant the access request.

21. The method of claim 20, wherein the response to the query for information from the physical key includes one or more data items from the group consisting of geographical data, expiration date data, and biometric data.

22. The method of claim 20, wherein determining whether the first designated recipient is required to have a physical security key comprises accessing, by the service provider system, at least a portion of the contents of the first set of vault access control instructions from the user system, the portion specifying whether a physical security key is required by the first designated recipient.

23. The method of claim 20, wherein determining whether the physical security key is valid comprises accessing, by the service provider system, at least one record from a physical key database maintained by the service provider system.
